(19) United States
(12) Patent Application Publication
(10) Pub. No.: US 2015/0298358 A1
(43) Pub. Date: Oct. 22, 2015

(54) COMPOSITE FIBER MATERIALS AND METHODS OF PROCESSING

(71) Applicant: Empire Technology Development LLC, Wilmington, DE (US)

(72) Inventor: Quentin Arthur Carl ADAM, Lane Cove (AU)

(21) Appl. No.: 14/646,702

(22) PCT Filed: Dec. 19, 2012
(86) PCT No.: PCT/US2012/070641

§ 371 Date: May 21, 2015

(51) Int. Cl. B29B 11/16; B05C 9/06; B05C 9/10; B05D 7/00; B05C 19/00

(52) U.S. Cl. CPC B29B 11/16; B05D 7/54; B05C 19/008; B05C 9/10; B05C 9/06; B29K 2063/00

(57) ABSTRACT

Provided herein are composite fiber materials, for example materials that include reused or recycled carbon fibers. In addition, methods of processing composite fibers, and methods of making composite fiber-containing materials are provided herein.

### TECHNICAL FIELD

Embodiments herein relate generally to composite fibers, materials that include composite fibers, and methods of processing, such as recycling, composite fibers.

### BACKGROUND

Composite fiber-containing materials such as carbon fiber-reinforced polymers are increasingly popular in automotive, aerospace, and renewable energy applications due to their lightweight and exceptional mechanical properties. These polymers are also recognized for their corrosion resistance and low thermal expansion properties.

### SUMMARY

Some embodiments provided herein include a method of processing composite fibers. The method can include selecting a plurality of fibers of approximately similar lengths. The method can include attaching the plurality of fibers to a surface of a substrate such that the plurality of fibers is aligned in a substantially parallel orientation. In some embodiments, the method includes cutting at least a part of the plurality of fibers along a plane substantially parallel to the surface of the substrate. The method can include applying a resin to at least the part of the plurality of carbon fibers. In some embodiments, the fibers of the plurality are arranged at an angle from about 5° to about 20° from a line that is parallel to the surface of the substrate. In some embodiments, the cutting includes cutting an end of a fiber distal to the surface of the substrate.

Some embodiments provided herein include a composite fiber material. The material can include a substrate. The material can include a plurality of fibers arranged in a substantially parallel orientation. In some embodiments, the plurality of fibers includes fibers of substantially the same length. In some embodiments, a first end of at least one fiber of the plurality of fibers is attached to the substrate. In some embodiments, the plurality of fibers includes fibers oriented at an angle that is acute to the substrate. The material can include a resin layer that contacts a second end of the at least one fiber. In some embodiments, the plurality of fibers includes recycled fibers. In some embodiments, the plurality of fibers includes carbon fiber nanotubes. In some embodiments, a standard deviation of a length of the plurality of fibers is no more than about 30% of a mean length of the plurality of fibers. In some embodiments, the plurality of fibers is arranged at an angle of about 20° or less to a surface of the resin layer.

Some embodiments provided herein include a method of supporting a load. In some embodiments, the method includes providing a structure. The structure can include a substrate. The structure can include at least a first fiber attached to the substrate by a first end of the first fiber. The substrate can include at least a second fiber attached to the substrate by a first end of the second fiber. In some embodiments, the first fiber and the second fiber are aligned in a substantially parallel orientation to each other. In some embodiments, first fiber and the second fiber are substantially the same length. In some embodiments, the first fiber and the second fiber are both arranged at an angle that is acute to the substrate. In some embodiments, a second end of the first fiber and a second end of the second fiber both contact a layer of resin. In some embodiments, the method includes applying a force to the structure and supporting the force with the structure, thereby supporting a load. In some embodiments, the structure has a tolerance for the force that is substantially the same as that of a structure including a plurality of fibers aligned perpendicular to the substrate. In some embodiments, the force is a tensile load that is applied at an angle that is approximately parallel to the plane of the substrate. In some embodiments, the first fiber includes a recycled fiber.

Some embodiments provided herein include a composite fiber structure. The composite fiber structure can include a substrate. The composite fiber structure can include a plurality of fibers that are arranged in a substantially parallel orientation. In some embodiments, a first end of each fiber of the plurality is attached to the substrate. In some embodiments, the length of each fiber of the plurality is within about ±10% of a mean length of the plurality of the fibers. In some embodiments, each fiber of the plurality is arranged at an angle of about 20° or less to the substrate. In some embodiments, each fiber of the plurality includes a recycled fiber. In some embodiments, each of the fiber of the plurality includes a graded fiber. In some embodiments, the substrate includes a silicone treated paper, a film of epoxy resin or polyethylene film or a combination of these. In some embodiments, a standard deviation of the length of the fibers is less than about 30% of a mean length of the fibers.

Some embodiments provided herein include a device for arranging fibers. The device can include a first support for a substrate. The device can include a carriage configured to deposit a plurality of fibers. In some embodiments, the carriage is configured to align the plurality of fibers in a substantially parallel orientation and deposit the plurality of fibers in a substantially parallel orientation along the substrate when the substrate is present on the support. The device can include a resin source configured to deposit resin on the plurality of fibers in the substantially parallel orientation along the substrate when the substrate is present on the support. In some embodiments, the device also includes a container configured to contain composite fiber materials to be recycled. In some embodiments, the carriage contains used composite fibers. In some embodiments, the support includes a conveyor. In some embodiments, the substrate, when present, includes silicone paper. In some embodiments, the device also includes a cutter that is configured to cut ends of at least some of the plurality of fibers when the plurality of fibers is attached to the substrate. In some embodiments, the cutter is configured to cut along a plane that is approximately parallel to a plane of the substrate. In some embodiments, the cutter includes at least one of a laser, an abrasive water jet, a high speed diamond cutting tool, or silicon carbide coated cutting tool.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1A is a graph depicting a relationship between the ratio of short to continuous fiber stress to multiples of the critical fiber length (Lc).

FIG. 1B is a graph depicting the relationship between fiber length and the frequency of those fibers, including a selection of fibers within a range of ±10% of the mean length of the selected fibers.

FIG. 2 is a graph depicting the relationship between fiber strength and the angle of the fiber from the major alignment axis.

FIG. 3 is a flow chart illustrating some embodiments of a method of processing fibers.

FIG. 4A is a drawing illustrating some embodiments of arrangements of fibers on a substrate.

FIG. 4B is a drawing illustrating some embodiments of trimming and resin-coating an arrangement of fibers on a substrate.

FIG. 5 is a drawing illustrating some embodiments of a fiber-containing material.

FIG. 6A is a drawing illustrating some embodiments of a device for arranging fibers.

FIG. 6B is a drawing illustrating some embodiments of a carriage configured to deposit fibers.

FIG. 7 is a flow chart illustrating some embodiments of supporting a force with a structure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Some embodiments provided herein relate to methods of recycling composite fiber materials, as well as various composite fiber materials.

Fiber containing materials, such as composite fiber material, can be useful for many applications and can include carbon fiber materials, such as carbon fiber nanotubes. While composite fibers are used in a wide variety of applications, it can be difficult for recycled fiber segments to achieve their original tensile properties if stitched end-to-end, as the joining of fibers is purely structural. The slightest misalignment of the end-to-end joint between two fibers alone can be much weaker than a continuous fiber. As such, these recycled composite fibers frequently only carry small tension loads, perhaps not even enough for spooling and weaving processes. Simply put, these re-joined and ‘kinked’ fibers can be weak and break easily.

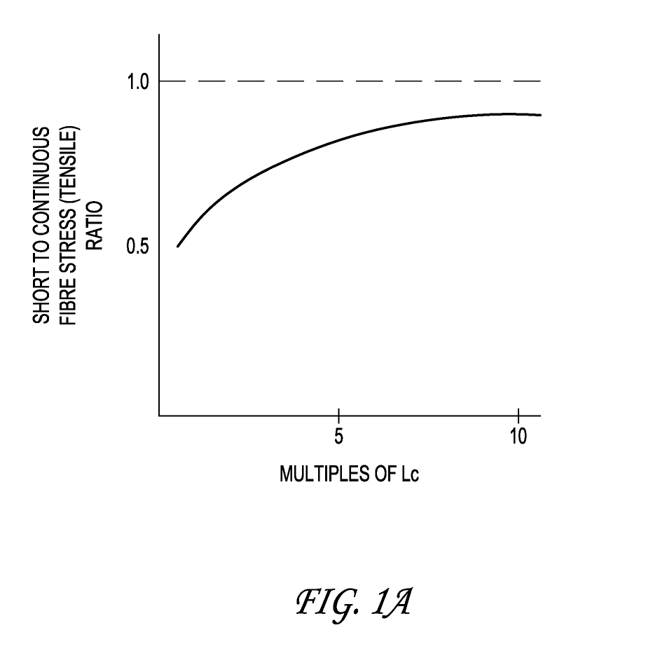

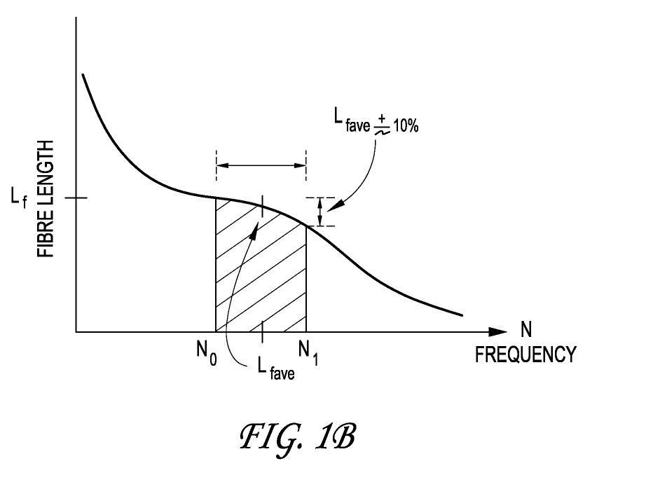

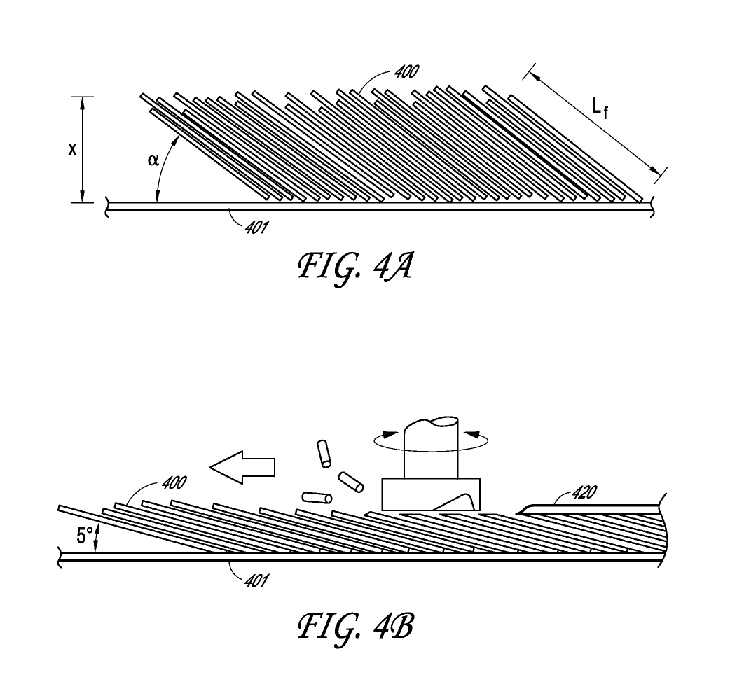

In contrast to an end-to-end approach, some embodiments herein utilize discontinuous fibers by carrying tensile loads via shear forces between the adjacent fibers in a matrix. Thus, instead of an end-to end approach, fibers of approximately similar length can be aligned substantially parallel to one another on a substrate. These aligned fibers can be, in some embodiments, cut to substantially the same length and then the cut ends of the fibers can be covered by a layer of resin. Such an arrangement provides a material that includes composite fibers that can bear a tensile load, without having to have the fibers aligned end to end (see, for example, the right side of FIG. 4B). The effectiveness of using such a parallel arrangement of numerous short fibers is graphed in FIG. 1A, where short fibers many multiples of the so-called critical fibers length, Lc, can be as effective as a continuous fiber.

In some embodiments, the average length of the fibers vary around a mean value (see FIG. 1B), so the average length selected, Lf, can be many multiples of Lc, for example 10, so that Lf=10 and Lc with a variation of ±30%. The distribution of lengths of fibers in a population can be depicted as a (as shown in FIG. 1B). In some embodiments, a subset of fibers having approximately the same length is selected from the population, such that the fibers of the subset each have a length within a certain percentage of a mean length, for example ±10%. In some embodiments, fibers of the subset each have a length that is within about ±30% of the mean length of the subset, for example a length within about ±30%, ±25%, ±22%, ±20%, ±18%, ±15%, ±12%, ±10%, ±9%, ±8%, ±7%, ±6%,±5%, ±4%, ±3%, ±2%, or ±1%, including any range defined between any two of the preceding ranges of values and any range to zero for any one of the preceding values.

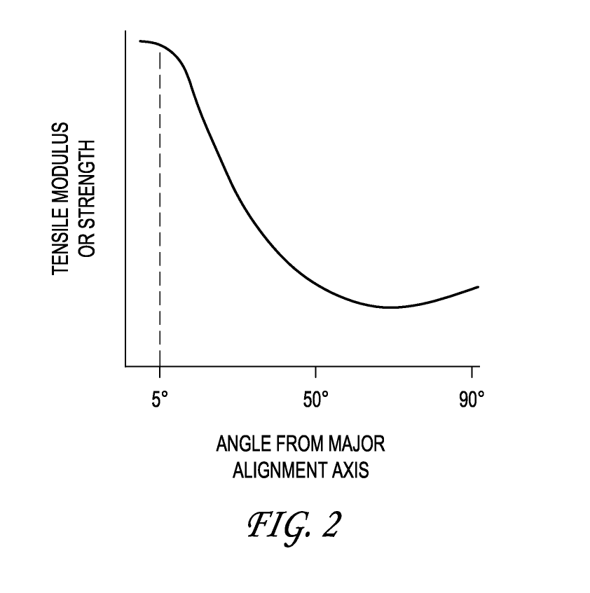

In some embodiments, fibers that are approximately aligned to the axis of tensile load, ‘θ’ up to around 5° from the axis, perform just as well as those that are in perfect alignment (see the left side of the graph in FIG. 2), having the same (or very similar) structural performance as continuous fibers for the same packing volume. Thus, in some embodiments, composite fiber structures that include these slightly “off alignment” of the fiber structure can be provided and such structures can be as strong or nearly as strong in their tensile strength as perfectly aligned, end-to-end structures. Moreover, this allows for a much simpler approach to recycling such composite fiber structures, as end-to-end alignment is no longer required, and instead side to side alignment can be used for placement of the fibers to be recycled.

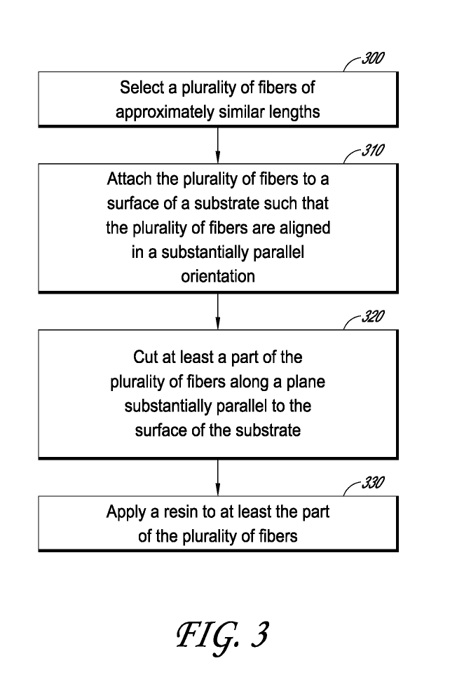

While there are a variety of ways of applying the aspects noted herein, FIG. 3 is a flow diagram illustrating some embodiments of a method of processing fibers in line with this side-to-side aspect. The method can include selecting a plurality of fibers of approximately similar lengths (block 300). One can then attach the plurality of fibers to a surface of a substrate such that the plurality of fibers is aligned in a substantially parallel orientation (block 310). If required (and thus optionally), the method can include cutting at least a part of the plurality of fibers along a plane substantially parallel to the surface of the substrate (block 320). This process allows for the ends of the fibers to terminate at approximately the same plane; however, if the lengths of the plurality of fibers are substantially the same, or if, for example, one aligns the ends of the plurality of fibers in a different manner, then the cutting process is not required. The method can further include applying a resin to at least some of the plurality of carbon fibers (block 330).

One skilled in the art will appreciate that, for this and other processes and methods disclosed herein, the functions performed in the processes and methods can be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIGS. 4A and 4B are drawings depicting the structural changes and arrangement in the embodiments outlined in FIG. 3.

FIG. 4A illustrates an arrangement of fibers 400 substantially parallel to each other. As shown in FIG. 4A, when the fibers 400 are arranged at an angle, α, to the plane of the substrate's 401 surface, then the height of a fibers, x, will be: x=Lf sin(α), in which Lf is the length of the fiber. Furthermore, when the fibers are stacked obliquely at an angle, α, and the height, x, will be: x=Lf sin(α)=10 Lc sin(α). The actual variation in x is much less than the variation in Lf if α small. Thus, having this angle also allows one to further reduce the variation in x, even before the cutting process.

As noted above, graded fibers 400 of approximately similar length can be attached to a resin base film (or other substrate 401), in a standing position. The exact initial alignment need not be critical, as the fibers can be then slightly flattened to lie at an acute angle to the substrate (see FIG. 4A, where the fibers 400 are already positioned at angle α). In some embodiments, such an arrangement is especially useful, as this arrangement itself provides the structural properties for a pre-preg.

As noted above, in some embodiments, the fibers 400 vary in length. However, after placement on the substrate, the majority of the variation will appear at the top-end of the stack (assuming a level substrate 401 is employed). FIG. 4B provides some embodiments of the process of cutting the ends of the uneven top fiber by, for example, machining. In some embodiments, one can then apply a resin layer 420 on top. Such a layer can serve to seal the cut fiber ends. Such a layer can also (or instead) serve to provide additional strength and/or elasticity to the product. If the variation in height ‘x’ is small then machining may not be needed and the topcoat can be applied directly. In some embodiments, a thicker and/or deeper layer of resin can be used so that varying lengths of fibers can be employed.

In some embodiments, the positioning of the fibers 400 on a substrate 401 and under a resin layer 420, provides a pre-preg type material with a very high volume fraction of carbon fiber. In some embodiments, there need not be many or any significant number of end-to-end gaps.

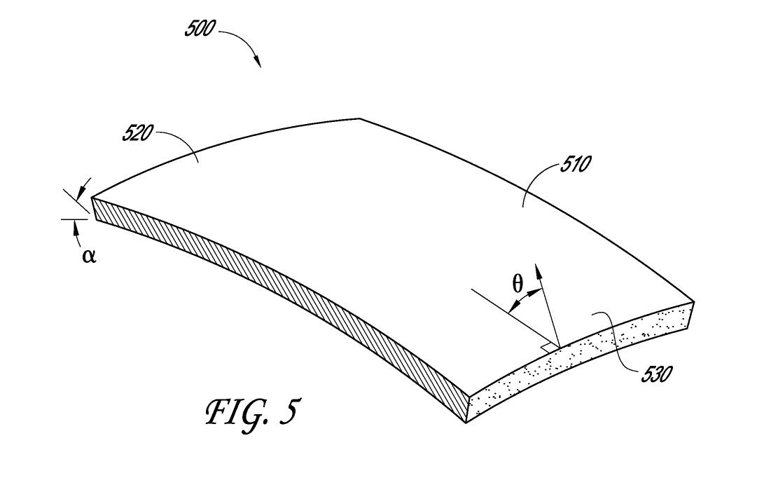

As shown in FIG. 5, in some embodiments, the carbon fibers 400 can further be oriented in the normal sense of θ to achieve different fiber orientations as expected from continuous carbon fiber. The material can have a resin top 510. The material can be oriented such that fibers at a first portion of the material 520 can be arranged at an acute angle α to the substrate, while fibers at a second portion of the material 530 can be arranged at a different acute angle θ to the substrate. Thus, such a system allows for differing angles of the fibers at different sections of the product.

In some embodiments, structures including the discontinuous fiber arrangement can be used to carry a tensile loads via shear between the adjacent fibers. As shown in FIG. 1A, short fibers many multiples of a critical fiber length, “Lc,” can be as effectively as continuous fibers. Accordingly, in some embodiments, fibers are at least 1 multiple of Lc, for example at least 1, 2, 3, 4, 5, 6, 7, 8, 9, 10, 11, 12, 13, 14, 15, 16, 17, 18, 19, 20, 25, 30, 35, 40, 45, 50, 60, 70, 80, 90, 100, or 500 multiples of Lc, including ranges between any two of the preceding values and ranges above any one of the preceding values.

In some embodiments, a subset of a population of fibers is selected (either for placement onto the substrate 401, or for further processing once placed onto the substrate). The subset can include fibers of approximately the same length; thus, subsequent processing of the fibers is not required in all embodiments. In some embodiments, the selected subset of fibers has a substantially uniform length. In some embodiments, the standard deviation of the length of the subset of fibers is no more than about 30% of the mean length, for example no more than about 30%, 25%, 20%, 15%, 12%, 10%, 9%, 8%, 7%, 6%, 5%, 4%, 3%, 2%, or 1% including ranges between any two of the preceding values and ranges below any one of the preceding values.

In some embodiments, the fibers are carbon fibers. In some embodiments, the carbon fibers include carbon fiber nanotubes. In some embodiments, the carbon fiber nanotube can include, but is not limited to, a hollow structure having a wall that includes at least one one-atom-thick layer of carbon. In some embodiments, carbon fiber naonotube can be single walled (for example, have a single layer of one-atom-thick layer of carbon). In some embodiments, carbon fiber naonotube can be multi-walled (for example, have more than one layer of one-atom-thick layer of carbon), for example double walled, triple walled, and the like. In some embodiments, the fibers include graded fibers.

While the embodiments provided herein explain that the various methods are especially useful for recycling composite fibers, and thus, in some embodiments the starting materials or methods involve recycled composite fibers, in some embodiments, the fibers being used are newly fabricated (and/or have not be used before). In some embodiments, recycled fibers include by-products from the fabrication of new materials. For example, the fibers can include off-cuts or trimmings from the manufacturing or processing of composite fiber materials. In some embodiments, recycled fibers can be recovered from a composite fiber-containing material, for example an unused pre-preg, or an end-of-life composite fiber-reinforced polymer material. In some embodiments, fibers come from different sources, for example, two or more different products and/or parts to be recycled.

In some embodiments, any size (length, width, or depth) fiber can be used. In some embodiments, the fiber has a diameter of about 10,000 nanometers or less, for example about 10,000, 1,000, 100, 90, 80, 70, 60, 50, 40, 30, 20, 10, 9, 8, 7, 6, 5, 4, 3, 2, 1.5, 1.2, 1.1, 1, 0.9, 0.8, 0.7, 0.5, 0.3, 0.2, or 0.1 nanometers, including any range above any one of the preceding values and any range between any two of the preceding values. In some embodiments a population of fibers is provided in which the fibers of the population have the same, or substantially the same, diameters. In some embodiments, a population of fibers is provided in which different fibers have different diameters. In some embodiments, the fiber has a length of about 1000 mm or less, for example about 1000, 100, 10, 1, 0.1, 0.01, 0.001, 0.0001, 0.00001, 0.000001, 0.0000001 mm, including any range above any one of the preceding values and any range between any two of the preceding values. In some embodiments, the fibers are in the form of tows (bundles of carbon fibers, usually in the thousands e.g. 1 k, 5 k, 10 k, 100 k etc).

In some embodiments, fibers are arranged on substrates as described herein. In some embodiments, any type of substrate can be employed. In some embodiments, a substrate includes at least one of a film, sheet, paper, or the like having a substantially flat surface. In some embodiments, the substrate includes at least one of a silicone treated paper, a film of epoxy resin, or a polyethylene film. In some embodiments, the substrate includes a combination two or more of any of these substances arranged in layers. Pliable or bendable substrates, such as tapes, films, papers, and gels can facilitate processing and storage of substances, for example pre-pregs of composite fibers positioned on a pliable substrate can be stored as rolls. Accordingly, in some embodiments, the substrate is pliable. In some embodiments, the substrate is rigid.

In some embodiments, the substrate has a thickness of at least about 1 nanometer, for example about 1, 2, 3, 4, 5, 6, 7, 8, 9, 10, 11, 12, 13, 14, 15, 17, 20, 25, 30, 25, 40, 25, 50, 60, 70, 80, 90, 100, 120, 150, 170, 200, 250, 300, 400, 500, 600, 700, 800, 900, 1,000, 2,000, 3,000, 4,000, 5,000, 6,000, 7,000, 8,000, 9,000, 10,000, 100,000, or 1,000,000 nanometers, including ranges between any two of the listed values and any range above any one of the preceding values.

Resins can be employed for forming substrates, and/or for reinforcing a composite fiber material, for example to form a pre-preg. In some embodiments, a fiber is coated in a resin, for example to form a pre-preg.

In some embodiments, the resin includes a thermoset-type resin, which can include, but is not limited to polyesters, vinyl esters, epoxies, bismaleimides, cyanate esters, polymides, phenolics, and the like. In some embodiments, the resin includes a thermoplastic, which can include, but is not limited to polyetherketone (PEEK), polyetherketoneketone (PEKK), polyetherimide (PEI), polyphetherimide (PEI), polyphenylene sulphide, polypropylene, and the like. In some embodiments, the resin and the substrate can be made of the same material. In some embodiments, the resin and the substrate are made of different materials.

Some embodiments include a method of processing composite fibers. The method can include selecting a plurality of fibers of approximately similar lengths, as described herein. The method can include attaching the plurality of fibers to a surface of a substrate such that the fibers are aligned in a substantially parallel orientation to one another. Optionally, the method can include cutting at least some of the plurality of fibers along a plane substantially parallel to the surface of the substrate. In some embodiments, the method includes applying a resin to at least a top part of the plurality of carbon fibers, such that one end of the fiber is attached to the substrate and one end is attached to the resin.

In some embodiments, selecting the plurality of fibers includes selecting an entire population of fibers to be attached to the substrate. In some embodiments, selecting the plurality of fibers includes selecting a subset of a population of fibers to be attached to the substrate, such that selection of fibers for addition to the substrate can be random, but a selection of common areas of height “x” can be selected later for application of the resin and/or selection. In embodiments, the selected fibers are approximately the same length, for example each of the selected fibers having a length within about ±30% of the mean length of the selected fibers. In some embodiments, each of the selected fibers has a length within about ±10% of the mean length of the selected fibers or less. Thus, fibers can be selected based upon this allowed length variation.

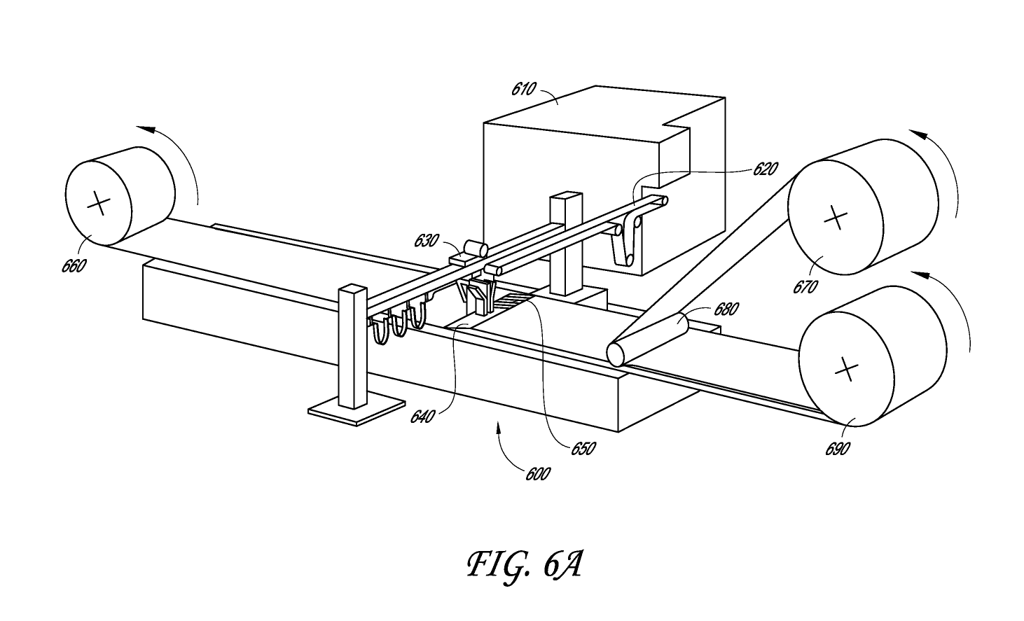

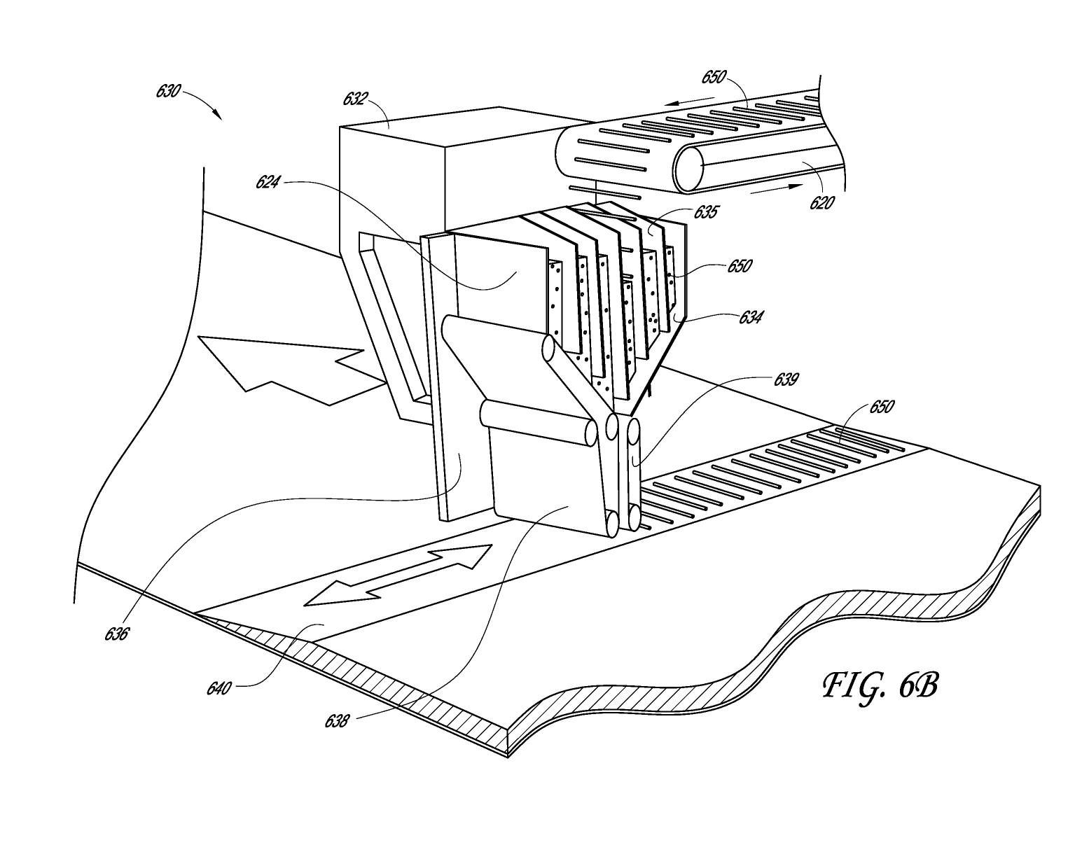

In some embodiments, the fiber can be attached to the substrate in a substantially parallel orientation to other fibers. In some embodiments, the selected fibers are aligned in a substantially parallel orientation to each other and then attached to the substrate. In some embodiments, the selected fibers are aligned in a substantially parallel orientation as they are attached to a substrate. In some embodiments, the selected fibers are attached to the substrate, and then aligned in a substantially parallel orientation to each other. For example the fibers can be attached to an adhesive or resin surface of the substrate before this adhesive or resin has set or cured, and the fibers can then be aligned. The fibers can be aligned in any number of ways, for example, in some embodiments, the fibers are aligned in a substantially parallel orientation via a mechanical device, for example as illustrated in FIG. 6B (for more detail, see discussion below). In some embodiments, the fibers are aligned in a substantially parallel orientation via an electromagnetic field, for example if the fibers are electromagnetically conductive. In some embodiments, the fibers are aligned in a substantially parallel orientation via a nanodevice, for example a robot. In some embodiments, the fibers are aligned in a substantially parallel orientation by passing the fibers through a sieve so that fibers that have passed through the sieve are arranged in a substantially parallel orientation, so that the fibers may then be attached to the substrate.

In some embodiments, the selected fiber is attached to a substrate. The fiber can be attached to the substrate at one end of each of the fibers. In some embodiments, the fibers are attached to the substrate via the chemical and/or physical characteristics of the substrate (for example, it is sticky, charged, uncured, etc.) In some embodiments, the fibers are attached to the substrate via the chemical and/or physical characteristics of the fibers (for example, it is sticky, charged, etc.) In some embodiments, the fibers are attached to the substrate via the chemical and/or physical characteristics of the substrate and/or the fibers (for example, they are sticky, charged, uncured, etc.) In some embodiments, the fibers are attached to the substrate via a third material, such as a glue or epoxy. In some embodiments, the fibers are attached to a substrate by way of an adhesive or resin on the surface of the substrate. In some embodiments, the fibers are attached to the substrate by an adhesive or resin that has been applied to an end of each of the fibers. In some embodiments, an end of the fiber is embedded in the substrate, thus attaching the fiber to the substrate.

In some embodiments, the fiber can be arranged in a substantially parallel orientation, such that each fiber is within an angle of about ±20° to a line that intersects the plane of the surface of the substrate, for example ±20°, ±19°, ±18°, ±17°, ±16°, ±15°, ±14°, ±13°, ±12°, ±11°, ±10°, ±9°, ±8°, ±7°, ±6°, ±5°, ±4°, ±3°, ±2°, ±1°, ±0.5°, ±0.2°, or ±0.1°, including ranges between any two of the listed values, and any range from any one of the preceding endpoints to 0° variation from the line. In some embodiments, at least a majority of the fibers on a substrate are substantially parallel with one another, for example, 50, 60, 70, 80, 90, 95, 98, 99, or 100 percent of the fibers are parallel with one another. In some embodiments, the act of packing the fiber, once laid on the substrate, can align the fibers further. In some embodiments, this can be done by running a roller transversely over each layer as they are applied. In some embodiments, at least a majority of the fibers that are on the substrate and coated with the top resin 420 are parallel with one another. In some embodiments, fibers that are parallel to one another can have some minor variation from an absolute parallel arrangement. Thus, in some embodiments, the fibers can vary from one another by, for example, ±20°, ±19°, ±18°, ±17°, ±16°, ±15°, ±14°, ±13°, ±12°, ±11°, ±10°, ±9°, ±8°, ±7°, ±6°, ±5°, ±4°, ±3°, ±2°, ±1°, ±0.5°, ±0.2°, or ±0.1°, including ranges between any two of the listed values and any range from any one of the preceding endpoints to 0° variation from the other fibers. In some embodiments, the fiber can be arranged and attached by the process as outlined in FIGS. 6A and 6B and the discussion thereof. In some embodiments, the fibers can be initially aligned by the application of a magnetic and/or physical force and/or process. In some embodiments, a magnetic field can be used to induce electro-static alignment of the fibers.

In some embodiments, the arrangement of fibers forms a composite fiber structure, as described herein.

As shown in FIG. 2, the tensile strength of a plurality of fibers aligned to the axis of a tensile load can relate to the angle between the fibers and the axis. While not intending to be bound by any particular theory, FIG. 2 demonstrates that the tensile strength of the fibers is predicted to be greater if they are aligned at an acute angle of about 70° or less to a line that is parallel to the surface of the substrate. Accordingly, in some embodiments, the fibers intersect a line that is parallel to the surface of the substrate at an angle of about 70° or less, for example about 70°, 60°, 50°, 45°, 40°, 35°, 30°, 25°, 20°, 17°, 15°, 13°, 12°, 11°, 10°, 9°, 8°, 7°, 6°, 5°, 4°, 3°, 2°, 1°, 0.5°, or 0.1°, including ranges between any two of the listed values and any range that is beneath any one of the two preceding values. In some embodiments, the fibers intersect a plane of the substrate at an angle of about 5° to about 20°. In some embodiments, the fibers intersect a line that is parallel to the surface of the substrate at an angle of about 5° to about 10°. In some embodiments, the fibers intersect a line that is parallel to the surface of the substrate at an angle of about 1° to about 20°. In some embodiments, the fibers intersect a line that is parallel to the surface of the substrate at an angle of about 1° to about 10°. In some embodiments, all or substantially all of the fibers between the substrate and the resin can have any one of the above angles of interaction. In some embodiments, at least 50% of the fibers will have at least one of the above angles, for example, at least 60, 70, 80, 90, 91, 92, 93, 94, 95, 96, 97, 98, 99, or 100 percent of the fibers will fall within an angle of any of the above (for example, 80° or less, 5° to 20°, 1° to 20°, 5° to 10°, etc).

In some embodiments, some or all of the of fibers are cut along a plane substantially parallel to the surface of the substrate (see, for example, FIG. 4B). In some embodiments, the fibers are cut after they are arranged at an acute angle to a line parallel to the surface of the substrate. In some embodiments, the fibers are cut before they are arranged at an acute angle to a line parallel to the surface of the substrate. In some embodiments, the cutting of the fibers starts before they are arranged at an acute angle to a line parallel to the surface of the substrate, but a force applied by the cutter moves the fibers into the acute angle.

In some embodiments, not all of the fibers need be cut, for example in embodiments in which a few fibers are substantially longer than other fibers of the population, only these substantially longer fibers could be cut. In some embodiments, at least about 90% of the fibers attached to the substrate are cut, for example at least about 90%, 91%, 92%, 93%, 94%, 95%, 96%, 97%, 98%, or 99%, including any range above any one of the preceding values and any range between any two of the preceding values. In some embodiments, effectively all of the fibers attached to the substrate are cut. In some embodiments, enough of the fibers are cut such that the applied resin on the top layer can contact a sufficient number of the fibers.

The fiber can be cut in any manner of ways. In some embodiments, the fibers are cut by at least one of a laser, an abrasive water jet, a high speed diamond cutting tool, or silicon carbide coated cutting tool. In some embodiments, the fibers are shortened by a grinder, thus reducing the fibers to a substantially uniform length. In some embodiments, two or more different types of cutting devices or processes are used.

As noted above, in some embodiments, the cutting step is optional. For example, in embodiments in which the plurality of fibers has a substantially uniform length, the cutting step can be omitted. Accordingly, in some embodiments in which the fibers have a substantially uniform length, no cutting step is performed. In some embodiments, in which the standard deviation of the length of the subset of fibers is no more than about 30% of the mean length, for example no more than about 30%, 25%, 20%, 15%, 12%, 10%, 9%, 8%, 7%, 6%, 5%, 4%, 3%, 2%, or 1%, no cutting step is performed. As shown in FIG. 4A, if the fibers are arranged at an angle, α, to the plane of the substrate's surface, then the height of a fibers, x, will be: x=Lf sin(α), in which Lf is the length of the fiber. Thus, the height x=N*Lc sin(α), in which N is the number of multiples of the critical length (Lc) that Lf represents. Accordingly, if α is a relatively small angle, the height x, will vary less, even if the fiber length Lf varies. Accordingly, in embodiments in which the plurality of fibers is arranged at a small angle α relative to the variation in fiber length, the cutting process can be omitted. In some embodiments, when α is less than about 20°, for example about or less than 20°, 19°, 17°, 15°, 13°, 12°, 11°, 10°, 9°, 8°, 7°, 6°, 5°, 4°, 3°, 2°, 1°, 0.5°, or 0.1°, and when the standard deviation of the length of the subset of fibers is no more than about 40% of the mean length, for example no more than about 35%, 30%, 25%, 20%, 15%, 12%, 10%, 9%, 8%, 7%, 6%, 5%, 4%, 3%, 2%, or 1%, no cutting process is performed. In some embodiments, even if the angle is shallow and/or the lengths are approximately the same, a cutting process can be performed.

In some embodiments, a resin is applied to at least some of the fibers. In some embodiments, the resin is applied to the ends of the fibers distal from the ends of the fibers that are attached to the substrate. In some embodiments, the resin is spread or brushed onto the fibers. In some embodiments, the resin is sprayed onto the fibers. In some embodiments, the fibers are dipped in a resin. In some embodiments, a resin film, or a pliable surface covered by resin is applied to the fibers. In some embodiments, after the resin is applied to the fibers, the resin is cured.

In some embodiments, a composite fiber structure can include a substrate and fibers that are arranged in a substantially parallel orientation as described herein. In some embodiments, one end of each fiber is attached to the substrate as described herein. In some embodiments, a length of each fiber is within about ±10% of a mean length of the plurality of the fibers.

An example of a composite fiber structure is illustrated in FIG. 4A. Carbon fibers 400 are arranged substantially parallel to each other as described herein. The carbon fibers 400 can be attached to substrate 401 as described herein.

In some embodiments, the composite fiber structure includes fibers that are arranged substantially parallel to each other as described herein.

In some embodiments, the composite fiber includes fibers that are attached to a substrate as described herein. In some embodiments, the fibers include graded fiber. In some embodiments, the substrate includes a silicone treated paper, a film of epoxy resin or polyethylene film or a combination of these.

In some embodiments, the composite fiber structure includes a plurality fibers that have a length within about ±30% of the mean length of the plurality of fibers, for example a length within about ±30%, ±25%, ±22%, ±20%, ±18%, ±15%, ±12%, ±10%, ±9%, ±8%, ±7%, ±6%,±5%, ±4%, ±3%, ±2%, or ±1% of the mean length. In some embodiments, the composite fiber structure includes a plurality of fibers that have a length within about ±10% of the mean length of the plurality of fiber

In some embodiments, the fibers are arranged an acute angle to a line that is parallel to a surface of the substrate as described herein. In some embodiments, each fiber of the composite fiber structure intersects a line that is parallel to the surface of the substrate at an angle of about 80° or less, as described herein. In some embodiments, each fiber of the composite fiber structure is arrange at an angle of about 80° or less to the substrate, for example about 80°, 70°, 60°, 50°, 45°, 40°, 35°, 30°, 25°, 20°, 17°, 15°, 13°, 12°, 11°, 10°, 9°, 8°, 7°, 6°, 5°, 4°, 3°, 2°, 1°, 0.5°, or 0.1°, including ranges between any two of the listed values. In some embodiments, the fibers of the composite fiber structure are arranged at an angle of about 5° to about 20° to the substrate. In some embodiments, the fibers of the composite fiber structure are arranged at an angle of about 1° to about 20° to the substrate. In some embodiments, the fibers of the composite fiber structure are arranged at an angle of about 1° to about 10° to the substrate. In some embodiments, the fibers of the composite fiber structure are arranged at an angle of about 5° to about 10° to the substrate.

In some embodiments, the composite fiber structure includes recycled fibers as described herein.

In some embodiments, the composite fiber structure includes graded fibers as described herein.

In some embodiments, the composite fiber structure includes a substrate, which can be made from a variety of materials. In some embodiments, the substrate includes silicone treated paper, a film of epoxy resin or polyethylene film or a combination of these.

In some embodiments, the structure formed by methods of processing carbon fibers described herein after attachment to a substrate, but prior to cutting the fibers can be a composite fiber structure. In some embodiments, the structure formed by methods of processing carbon fibers described herein after arrangement of the fibers at an acute angle to a line that is parallel to the surface of the substrate, but prior to cutting the fibers can be a composite fiber structure. In some embodiments, the structure formed by methods of processing carbon fibers described herein after cutting the fibers, but prior to application of resin can be a carbon fiber structure.

In some embodiments, the fibers of the composite fiber structure have not been cut as described herein. In some embodiments, the composite fiber structure includes fibers whose ends distal to the substrate are not contacted by resin as described herein. In some embodiments, none of the ends of the fibers distal to the substrate in the composite fiber structure are contacted by resin.

Methods of processing composite fibers described herein can produce composite fiber materials. Accordingly, some embodiments include composite fiber materials. In some embodiments, the composite fiber material includes a substrate as described herein. In some embodiments, the composite fiber material includes a plurality of composite fibers arranged in a substantially parallel orientation as described herein. An end of one or more composite fibers of the plurality of composite fibers can be attached to the substrate, as described herein. The composite fibers can be oriented at an angle that is acute to the substrate, as described herein. Another end of the one or more composite fibers (the end that does not contact the substrate) can be contacted by a resin layer as described herein.

FIG. 4B illustrates an exemplary composite fiber material being formed. Fibers 400 are substantially parallel to each other, and arranged at an acute angle to a substrate 401. The fibers 400 are attached to the substrate 401 at one end. The fibers 400 are covered by a resin 420 at the other end.

In some embodiments, the composite fiber material includes a substrate and one or more fiber. In some embodiments, the composite fiber material includes one or more fiber and the resin coating 420. In some embodiments, the composite fiber material includes the substrate 401, one or more fiber 400, and the coating resin 420.

In some embodiments, the composite fiber material can be shaped for a particular application. In some embodiments, the composite fiber material can be in the form of a pre-preg. In some embodiments the pre-preg is and/or can be molded, bent, rolled, folded, or otherwise shaped to a desired form. In some embodiments, the composite fiber material is shaped, so that composite fibers at a first portion of the material are arranged at a first acute angle to the substrate, and composite fibers at a second portion of the material are arranged at a second acute angle to the substrate. The first angle can be different from the second angle. Accordingly, as illustrated in FIG. 5, different portions of the material can have different strengths for carrying a tensile force.

In some embodiments, the composite fiber material forms a substantially flat sheet. In some embodiments, the composite fiber material forms a curved sheet. In some embodiments, the composite fiber material forms a tube. In some embodiments, the composite fiber material forms a pre-preg arranged on a roll, for example for storage or shipping.

Composite fiber structures as described herein can be useful for withstanding various forces and/or loads. In some embodiments, the structures can support a tensile force, and can be used, for example, to support a load. Accordingly, some embodiments include a method of supporting a load and/or resisting a force by using such a composite fiber. In some embodiments, the method includes providing a structure that includes a substrate and the fibers attached to the substrate. The fibers of the structure can be arranged substantially parallel to each other, and can be attached to the substrate at one end of each composite fiber. The structure can include a layer of resin that contacts the ends of the fibers that are not attached to the substrate.

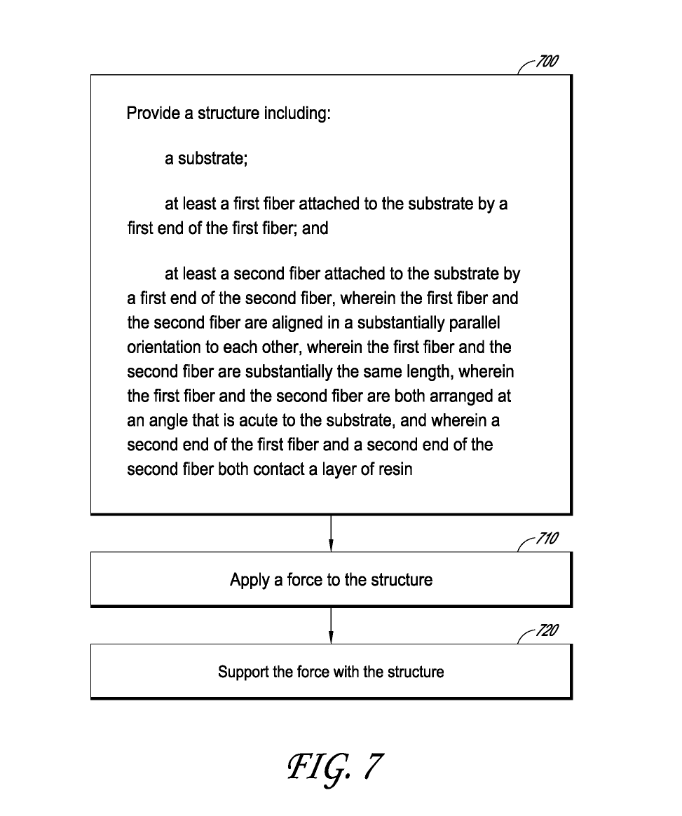

FIG. 7 is a flow chart illustrating some embodiments of a method of supporting a load. In some embodiments, a structure is provided (block 700). The structure includes a substrate. The structure can include at least a first fiber attached to the substrate by a one end of the first fiber, and at least a second fiber attached to the substrate by one end of the second fiber. The first fiber and the second fiber can be aligned in a substantially parallel orientation to each other. The first fiber and the second fiber can be substantially the same length as described herein. Both the first fiber and the second fiber can be both arranged at an angle that is acute to the substrate. The other end of the first fiber and the other end of the second fiber can both contact a layer of resin. In some embodiments, a force is applied to the structure 710. In some embodiments, a load is supported with the structure 720.

In some embodiments, the structure provided is or includes a composite fiber material as described herein.

In some embodiments, the force is applied to the composite material along an axis. In some embodiments, the force is applied at an angle of about 90° to a line parallel to the substrate of the composite fiber material. In some embodiments, the force is applied along an axis at an angle of less than about 90° to a line parallel to the substrate of the composite fiber material, for example about 90°, 89°, 88°, 87°, 85°, 82°, 80°, 75°, 70°, 65°, 60°, 55°, 50°, 45°, 40°, 35°, 30°, 25°, 20°, or 10° to the line, including any range between any two of the preceding values and any range beneath any one of the preceding values.

In some embodiments the applied stress is of the order of 1 MPa or more. In some embodiments, the force is at least about 2 MPa, for example, at least about 2, 3, 4, 5, 6, 7, 8, 9, 10, 15, 20, 25, 30, 40, 50, 60, 70, 80, 90, 100, 150, 200, 250, 300, 350, 400, 450, 500, 600, 700, 800, 900, or 1000 MPa (including any range between any two of the preceding values and any range above any one of the preceding values.

In some embodiments, the force can be applied for any amount of time. In some embodiments, the force is applied continuously. In some embodiments, the force is applied continuously for at least about 1 millisecond, for example about 1 millisecond, 2, 3, 5, 10, 20, 30, 40, 50, 70, 80, 100, 150, 200, 300, 400, 500, 700, or 1000 milliseconds, including any range between any two of the preceding values and any range above any one of the preceding values. In some embodiments, the force is applied continuously for at least about 1 second, for example about 1, 2, 3, 4, 5, 6, 7, 8, 9, 10, 11, 12, 13, 14, 15, 16, 17, 18, 19, 20, 25, 30, 35, 40, 45, 50, 55, or 60 seconds, including any range between any two of the preceding values and any range above any one of the preceding values. In some embodiments, the stress is applied continuously for at least about 1 minute, for example about 1, 2, 3, 4, 5, 6, 7, 8, 9, 10, 11, 12, 13, 14, 15, 16, 17, 18, 19, 20, 25, 30, 35, 40, 45, 50, 55, 60, 70, 80 ,90, 100, 110, 120, 150, 180, 240, 300, 360, 420, 480, 540, 600, 660, or 720 minutes, including any range between any two of the preceding values and any range above any one of the preceding values. In some embodiments, the stress is applied cyclically. In some embodiments, alternating cycles of stress and no stress are applied. In some embodiments, alternating cycles of a first stress and a second stress are applied, in which the first stress and second stress are of different magnitudes and/or directions. In some embodiments, 1 or more cycles, for example at least 1, 2, 3, 4, 5, 6, 10, 15, 20, 30, 40, 50, 70, or 100 cycles or more are applied, including any range between any two of the preceding values and any range above any one of the preceding values. In some embodiments the application of one or more stresses, in different directions and magnitudes, may be random (stochastic).

In some embodiments, the stress includes a downward force from the weight of an object being supported by the composite material. In some embodiments, the stress includes tensile stress from structures abutting the composite material, for example in an automobile body or aircraft hull. In some embodiments, the stress is due to an impact against a surface of the composite material, for example in athletic equipment.

Some embodiments include a device for arranging composite fibers. The device can include a first support for a substrate. In some embodiments, the device can include a carriage configured to deposit a plurality of composite fibers onto a substrate, when the substrate is on the support. The carriage can be configured to align the plurality of composite fibers in a substantially parallel orientation and deposit the plurality of composite fibers in a substantially parallel orientation along the substrate when the substrate is present on the support. In some embodiments, the device can include a resin source configured to deposit resin on the plurality of composite fibers in the substantially parallel orientation along the substrate when the substrate is present on the support. In some embodiments, the device includes a channel and/or flow path for delivering a resin to an area over the support.

FIG. 6A illustrates some embodiments for a device 600 for arranging fibers. In some embodiments, the device includes a container 610 configured to contain composite fiber materials to be recycled. In some embodiments, the device includes a conveyor 620 configured to transport composite fibers from the container 610 to a carriage 630 for depositing composite fibers 650. When a substrate is present on the first support 640, the carriage can deposit composite fibers in a substantially parallel orientation. In some embodiments, the first support 640 includes a conveyor, for example a conveyor belt, rollers, or the like. In some embodiments, the first support 640 includes a fixed stage. In some embodiments, the first support 640 includes a removable tray, platform, or bracket. In some embodiments, a substrate as described herein is positioned over the first support. In some embodiments, the device includes a supply 660 of substrate which is applied to the support 640 provide at least a single layer of substrate covering the first support 640. By way of example, the supply 660 can include a roll. In some embodiments, the device includes a supply of top coating 670 for coating a deposited composite fiber material.

In some embodiments, the container 610 is configured to contain composite fiber material (such as material including fibers) to be recycled. In some embodiments, the container includes at least one of a hopper, a well, a bucket, a canister, a box, a tank, a silo, a cylinder, a bag, or a pouch. In some embodiments, the container is configured to hold a volume of at least about 0.5 liters of composite fiber material to be recycled, for example at least about 0.5, 1, 2, 3, 4, 5, 6, 7, 8, 9, 10, 12, 15, 16, 19, 20, 25, 30, 40, 50, 60, 70, 80, 90, 100, 120, 150, 180, 200, 250, 300, 400, 500, 600, 700, 800, 900, or 1000 liters of composite fiber material to be recycled, including any range between any two of the preceding values and any range above any one of the preceding values.

In some embodiments, the conveyor 620 extends from the container 610 to the carriage 630. In some embodiments, the conveyor 620 includes a conveyor belt. In some embodiments, the conveyor 620 includes a pipe, chute, channel, or the like. In some embodiments, the conveyor 620 includes a gondola configured to move carbon fiber material from the container 610 to the carriage 630. In some embodiments, the conveyor 620 includes a robotic arm configured to remove carbon fiber material from the container 610 and deposit it in the carriage 630, or directly on the substrate.

An exemplary carriage 630 is illustrated in FIG. 6B. In some embodiments, the carriage includes a backside dam 632 and a hopper 634 configured to store and/or arrange fibers 650 in a desired orientation. In some embodiments, the hopper 634 includes at least one channel (for example at least one, two, three, four, five, six, seven, eight, nine, ten or more channels). The channel can be defined by either a substantially vertical divider 635 on one side and a side of the hopper 624 on the other side, or a pair of substantially vertical dividers 635. In some embodiments, the backside dam 632 further defines each channel. In some embodiments, each channel has a width at least twice the diameter of a carbon fiber provided by the container 610 (for example at least 2×, 3×, 4×, 5×, 6×, 7×, 8×, 9×, 10×, 15×, 20×, 30×, 40×, 50×, 60×, 70×, 80×, 90×, 100× or 200× the diameter, including any range between any two of the preceding values and any range above any one of the preceding values), but a width that is less than the length of at least 95% of the carbon fibers in the container. In some embodiments, each channel extends from the top of the hopper, and opens onto an opening at the bottom of the hopper.

In some embodiments, the opening at the bottom of the hopper is positioned over a pair of belts 638 and 639. The first belt 638 of the pair can be configured in an obtuse “V” shape to collect fibers from the opening at the bottom of the hopper. The second belt 639 can be configured to run parallel to a lower segment of the first belt 639. The first belt 638 and 639 can be configured to coordinately move the fibers 650 in a single direction, so that the fibers are moved to the support 640. In some embodiments, the belts can be positioned apart by a distance at least twice the diameter of the fibers, but positioned apart by no more than one half of a length of at least 95% of the fibers in the container, so as to maintain the fibers 650 in a substantially parallel orientation when they are deposited onto a substrate positioned on the support 640. In some embodiments, the carriage includes a cutter for cutting composite fibers along a plane substantially parallel to the substrate as described herein. In some embodiments, the carriage includes a resin sprayer and/or a resin spreader configured to deposit a layer on resin over the composite fibers arranged on the substrate.

In some embodiments, the carriage 630 is tilted at an angle relative to the plane of the substrate on the support 640, so as to deposit the fibers at an angle. In some embodiments, the angle of the carriage is substantially the same as the alpha angle (α) between the composite fibers and the substrate, which is described herein. The carriage can be configured to move laterally, for example by being suspended on a bracket, so as to deposit a row of composite fibers 400 (see, for example, FIG. 6B). In some embodiments, the support 640 moves the substrate forward, so that the carriage deposits sequential rows of composite fibers on the substrate. Accordingly, in some embodiments, the device produces a composite fiber material, for example a pre-preg. In some embodiments, the hopper locally stores the fibers all aligned in one orientation. Vertical plates inside the hopper can reduce the fibers from jamming (“bridging”). In some embodiments, the device is tilted back so that it is perpendicular to the tilt angle of the fibres on the pre-preg roll (the angle alpha). In some embodiments there are two powered belts (638 and 639), one short straight and the other an obtuse ‘V’, running back to back in contact with one another that pick up the individual fibres from the hopper and throw them at the pre-preg surface. In some embodiments, there is a rectangular backside dam 632 to reduce fibers from sliding ahead for larger tilt angles but can be useful to reduce stray resin spray going ahead of the device. In some embodiments, the top and bottom silicone treated papers on let-off rolls are rotated incrementally while the wind up roll collects the finished pre-preg. Incrementing the advance of the sheets by the average fiber length (for example, the Cosine(alpha) of the average fiber length) each time the depositing device traverses the cross frame once allows the layers of the pre-preg to build up.

With reference to FIG. 6A, in some embodiments, the device includes a first supply of substrate. The substrate can be as describe herein. In some embodiments, the supply 660 of substrate is a roll of substrate. In some embodiments, the supply 660 of substrate is a spreader or sprayer that spreads a liquid or gel substrate onto the support 640. In some embodiments, a single layer of substrate is deposited from the supply 660 onto the support. In some embodiments, the device includes a supply of resin 670. In some embodiments, the resin material is the same material as the substrate. In some embodiments, the supply of resin 670 includes a roll of resin material, for example silicone paper.

In some embodiments, the device includes an applicator 680 to apply the resin to the top of the fiber material generated by the device. In some embodiments, for example when the resin material 670 is supplied by a roller, the applicator 680 is a second roller configured to roll at least a layer of resin material onto the composite fiber material. In some embodiments, for example when the resin 670 is a liquid or gel, the applicator 680 is a sprayer or spreader. In some embodiments, the device includes a roller 690 for rolling composite fiber material (for example a pre-preg). The roll of composite fiber material can facilitate storage, shipping, and/or application.

In some embodiments, segments of recycled tows (bundles of carbon fibers, usually in the thousands e.g. 5 k) are collected and used in the method and devices outlined herein. The twos can be machine deposited so that they lie parallel to each other but at an angle of, for example, 5 degrees (or less) to the surface of the substrate. The deposition can occur in a raster like pattern with the deposition in any particular row moving in a direction perpendicular to the axis of the tows. In some embodiments, each additional row of tows is added substantially on top of the previous row, since the previous row is oriented at an acute angle to the substrate.

Some embodiments include a pre-preg composite sheet made from discontinuous, or recycled, carbon fibers. Graded fibers of approximately similar length are attached to a broadsheet resin base film substrate, standing up, and then slightly flattened to lie at an acute angle to the base. In some embodiments, the fibers will inevitably vary at least slightly in length, and substantially most of the variation at the top-end of the stack can be trimmed down to an adequately uniform measurement. A thin liquid resin layer applied over the top of the stack seals the cut fiber ends, and the result is a pre-preg material with a very high volume fraction of carbon fiber. This type of fiber arrangement can reclaim desirable structural properties for pre-preg by carrying tensile loads via shear between the adjacent fibers in a matrix. In some embodiments, this can be as effective as employing continuous fibers.

Some embodiments include a pre-impregnated (pre-preg) composite sheet made from discontinuous, or recycled, fibers (such as carbon fibers).

### EXAMPLE 1

### Production of a Composite Fiber Structure

Single walled carbon fiber nanotubes are recovered from discarded sports equipment. The recovered nanotubes have lengths ranging from about 5 to about 500 micrometers. A subset of the nanotubes having a mean length of 100 micrometers, and in which each selected nanotube has a length within ±5% of the mean (e.g. lengths ranging from 95-105 micrometers). The selected nanotubes are arranged in parallel to each other, and then deposited as a batch substantially perpendicular to a substantially flat 2-micrometer-thick film of uncured epoxy resin. The tops of the nanotubes are pushed along an axis parallel to the surface of the substrate, thereby positioning the nanotubes substantially parallel to each to each other, and at an angle (α) of 7° to a line that is parallel to the surface of the substrate. The heights of the tubes vary from 95 nanometers*sin) (7°) to 105 nanometers*sin)(7°) to (11.6 to 12.8 nanometers). No cutting is applied to the nanotubes. Subsequently, the nanotubes can be covered in a thin layer of polyester resin. This thereby provides a composite fiber structure based upon substantially parallel carbon fiber nanotubes.

### EXAMPLE 2

### Production of a Composite Fiber Material

Individual carbon fiber cuttings from an aircraft composite materials factory are collected. A subset of the cuttings having a mean length of 5 millimeters is selected, in which the lengths of the selected cutting are about 5±0.5 millimeters. The carbon fibers are arranged in parallel with each other and perpendicular to the surface of a silicone paper substrate so that one end of the fiber is in the substrate, and the other end of the fiber is not touching the substrate. A force is applied to the carbon fibers so that they intersect the surface of the substrate at an angle α, of about 20°, thus producing a composite fiber structure. A laser cutter cuts the fibers along a plane parallel to the surface of the substrate and about 15 nanometers above the surface of the substrate, thus producing a layer of carbon fibers having a thickness of about 1.5 millimeters above the substrate, in which the carbon fibers of the layer are substantially the same length A 0.05 mm layer of vinyl ester resin is deposited over the freshly-cut surface of the carbon fibers. The resin is cured, thereby producing a composite fiber material.

### EXAMPLE 3

### Load-Bearing Composite Fiber Material

A pre-preg that includes a silicone paper substrate, single-walled carbon fiber nanotubes substantially parallel to each other, and arranged at an angle (α) of 20° to the surface of the substrate is provided. The pre-preg is shaped as a substantially flat sheet. The pre-preg is set, thus forming a carbon-fiber reinforced polymer sheet. A downward force is applied at an angle of 5 degrees from the surface of the sheet without breaking the sheet.

### EXAMPLE 4

### Method of Placing Tows

Segments of recycled tows (bundles of carbon fibers, usually in the thousands e.g. 5 k) are collected. A subset of tows that have a mean length of 50 mm+/−5 mm is selected. These tow segments are machine deposited so that they lie parallel to each other but at an angle of 5 degrees to the surface of an epoxy film substrate. The deposition occurs in a raster like pattern with the deposition in any particular row moving in a direction perpendicular to the axis of the tows. Each additional row of tows is added substantially on top of the previous row, since the previous row is oriented at an acute angle to the substrate. The top of the deposited tows, the ends furthest from the substrate, is capped off with a layer of tacky epoxy film to create a sandwich construction.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method of processing fibers, the method comprising:
selecting a plurality of fibers of approximately similar lengths,
attaching the plurality of fibers to a surface of a substrate such that the plurality of fibers are aligned in a substantially parallel orientation;
cutting at least a part of the plurality of fibers along a plane substantially parallel to the surface of the substrate; and
applying a resin to at least the part of the plurality of fibers.

2. The method of claim 1, wherein the fibers of the plurality are arranged at angle of from about 5° to about 20° from a line that is parallel to the surface of the substrate.

3. The method of claim 1, wherein cutting comprises cutting an end of a fiber distal to the surface.

4. A composite fiber material comprising:
a substrate;
a plurality of fibers arranged in a substantially parallel orientation, wherein a first end of at least one fiber of the plurality of fibers is attached to the substrate, wherein the plurality of fibers comprise fibers of substantially the same length, and wherein the plurality of fibers comprises fibers oriented at an angle that is acute to the substrate; and
a resin layer that contacts a second end of the at least one fiber.

5. The composite fiber material of claim 4, wherein the plurality of fibers comprises recycled fibers from a composite fiber material.

6. The composite fiber material of claim 4, wherein the plurality of fibers comprises carbon fiber nanotubes.

7. The composite fiber material of claim 4, wherein a standard deviation of a length of the plurality of fibers is no more than about 30% of a mean length of the plurality of fibers.

8. The composite fiber material of claim 4, wherein the plurality of fibers is arranged at an angle of about 20° or less to a surface of the resin layer.

9. A method of supporting a load, the method comprising:
providing a structure comprising:
a substrate;
at least a first fiber attached to the substrate by a first end of the first fiber; and
at least a second fiber attached to the substrate by a first end of the second fiber, wherein the first fiber and the second fiber are aligned in a substantially parallel orientation to each other, wherein the first fiber and the second fiber are substantially the same length, wherein the first fiber and the second fiber are both arranged at an angle that is acute to the substrate, and wherein a second end of the first fiber and a second end of the second fiber both contact a layer of resin;
applying a force to the structure; and
supporting the force with the structure, thereby supporting a load.

10. The method of claim 9, wherein the structure has a tolerance for the force that is substantially the same as that of a structure comprising a plurality of fibers aligned perpendicular to the substrate.

11. The method of claim 9, wherein the force is a tensile load that is applied at an angle that is approximately parallel to the plane of the substrate.

12. The method of claim 9, wherein the first fiber comprises a recycled fiber.

13. A composite fiber structure comprising:
a substrate; and
a plurality of fibers that are arranged in a substantially parallel orientation, wherein a first end of each fiber of the plurality is attached to the substrate, wherein a length of each fiber of the plurality is within about ±10% of a mean length of the plurality of the fibers.

14. The composite fiber structure of claim 13, wherein each fiber of the plurality is arranged at an angle of about 20° or less to the substrate.

15. The composite fiber structure of claim 13, wherein each of the fiber of the plurality comprises a recycled fiber.

16. The composite fiber structure of claim 13, wherein the each of the fiber of the plurality comprises a graded fiber.

17. The composite fiber structure of claim 13, wherein the substrate comprises a silicone treated paper, a film of epoxy resin or polyethylene film or a combination of these.

18. The composite fiber structure of claim 13, wherein a standard deviation of the length of the fibers is less than about 30% of a mean length of the fibers.

19. A device for arranging fibers, the device comprising:
a first support for a substrate;
a carriage configured to deposit a plurality of fibers, wherein the carriage is configured to align the plurality of fibers in a substantially parallel orientation and deposit the plurality of fibers in a substantially parallel orientation along the substrate when the substrate is present on the support; and
a resin source configured to deposit resin on the plurality of fibers in the substantially parallel orientation along the substrate when the substrate is present on the support.

20. The device of claim 19, the device further comprising a container configured to contain composite fiber materials to be recycled.

21. The device of claim 19, wherein the carriage contains used composite fibers.

22. The device of claim 19, wherein the support comprises a conveyor.

23. The device of claim 22, wherein the substrate, when present, comprises silicone paper.

24. The device of claim 19 further comprising a cutter that is configured to cut ends of at least some of the plurality of fibers when the plurality of fibers is attached to the substrate, wherein the cutter is configured to cut along a plane that is approximately parallel to a plane of the substrate.

25. The device of claim 24, wherein the cutter comprises at least one of a laser, an abrasive water jet, a high speed diamond cutting tool, or silicon carbide coated cutting tool.
